(19) United States
(12) Patent Application Publication
(10) Pub. No.: US 2012/0144390 A1
(43) Pub. Date: Jun. 7, 2012

(54) CUSTOMIZED COMPUTER IMAGE PREPARATION AND DEPLOYMENT INCLUDING VIRTUAL MACHINE MODE

(75) Inventors: Aaron Farmer, Seattle, WA (US); Angad Kamat, Redmond, WA (US); George E. Roussos, Seattle, WA (US); Chad Richard Siefert, Seattle, WA (US); Olga B. Ivanova, Redmond, WA (US)

(73) Assignee: Microsoft Corporation, Redmond, WA (US)

(21) Appl. No.: 12/962,458

(22) Filed: Dec. 7, 2010

(51) Int. Cl. G06F 9/455

(52) U.S. Cl. 718/1

(57) ABSTRACT

A computer-implemented technique significantly reduces the time required to configure software images deployed from a golden reference machine to destination machines. Time is saved by applying a priori knowledge of the configuration of the intended destination machines and omitting normally run configuration steps known to be non-essential or irrelevant to the destination machines. This technique is particularly advantageous when the destination machines are virtual machines, as time-consuming commands for configuring hardware on the destination machines can be avoided.

### BACKGROUND

This invention relates generally to techniques for configuring software images and deploying them on different computing machines, and, more particularly, to techniques for reducing the time needed to configure computing machines that receive deployed software images.

Administrators of IT departments and server arrays are commonly called upon to configure new computers. One approach is to configure each computer individually from scratch. The process begins with loading the operating system and proceeds to installing each program to be included. This manual approach often requires several hours or even days. It also requires a great deal of user interaction and is therefore both labor intensive and prone to human error.

A much faster approach is to prepare a single computer, which serves as a template for other computers to be configured. The desired operating system and programs are loaded onto this golden or “reference” computer, and the “software image” of the reference computer, i.e., the entire contents of the computer's disk drive or other permanent storage medium, is then copied, or “cloned,” to one or more “destination” computers, i.e., new machines to be set up or older machines to be wiped clean and configured like the reference computer.

The process of cloning computers is generally more complex than simply copying the software image of the reference machine to the destination machines and booting. For example, each destination machine must generally have its own unique computer name. If the destination machine is a Windows® machine, it must also have its own unique security identifier, or SID. These must be established on each destination machine to avoid network conflicts with the reference machine and with other destination machines receiving the same software image. In addition, it is common for the hardware of each destination machine to differ from that of the reference machine or from one another. The destination machines may not operate, or operate correctly, when simply loaded with the software from the reference machine. It is therefore generally essential to install new device drivers on each destination machine, which are specific to the particular hardware of the respective destination machine.

As is known, a tool called SYSPREP has been developed to simplify the various configuration tasks involved in cloning software images. SYSPREP is typically run in two phases. The first phase is known as “Generalize” and is run on the reference machine prior to cloning. The second phase is known as “Specialize” and is run on each destination machine after the software image of the reference machine has been loaded. The Generalize phase prepares the software image of the reference machine by removing machine-specific information, such as computer name and SID. It performs a myriad of other tasks, such as disabling device drivers, removing user-specific information, invalidating caches, removing event logs, and setting registry keys. After the Generalize phase is run, the software image is left in a state that is generic to hardware, so that the software image may be booted and set up on machines of any hardware configuration.

The Specialize phase is invoked on each destination machine the first time the destination machine is booted after receiving the software image. “Specialize” runs various tasks, including obtaining a new computer name and SID, enabling a local administrator account, setting caches and registry keys, detecting hardware, and installing drivers. The role of Specialize is to bind the generic software image to the particular hardware and environment of the destination machine, so that the hardware and software of the destination machine can coordinate as intended.

When using SYSPREP, the time required to configure a newly cloned machine is typically much less than the time needed to reinstall all software from scratch. SYSPREP also produces a more reliable, repeatable result, which requires much less user interaction and therefore involves less labor and opportunity for human error.

In recent years, demand has increased for configuring new systems ever more quickly. Although configuring a system using SYSPREP typically takes only minutes, even this short time can be burdensome when many computers are involved.

Configuration speed can be particularly critical when the destination machines are virtual machines. As is known, “virtual machines” are computing machines defined not by their hardware but by their software and state information. Although virtual machines are run on hardware, they are designed to be readily transportable between different hardware environments. Powerful servers can be used to run many virtual machines at once, and virtual machines can be readily moved from one server to another in response to demand to provide load balancing and to optimize hardware allocation.

One possible scenario for future computing trends is for users to obtain most of their computing power from arrays of servers that run virtual machines. According to this scenario, a user can request a virtual machine for the user's personal computing, as needed, and a new virtual machine will be dynamically deployed and configured as the user waits. Once the virtual machine is fully configured, it will be available to the user and provide an experience similar to that of running a physical computer on the user's own desktop. Since, in this scenario, there will be many users who all need to wait for their systems to be configured, configuration time is especially critical.

What is needed, therefore, is a rapid way of configuring cloned computing machines, especially virtual machines.

### SUMMARY

The above-described need is met by a computer-implemented technique for significantly reducing the time required to configure software images deployed from a golden reference machine to destination machines. Time is saved by applying a priori knowledge of the configuration of the intended destination machines and omitting normally run configuration commands known to be non-essential or irrelevant to the destination machines.

The time required for configuring hardware generally makes up the vast majority of overall time spent configuring newly deployed machines. Therefore, this technique is particularly advantageous when deploying virtual machines, wherein time consuming commands for configuring hardware can be omitted.

In accordance with one embodiment hereof, a method of replicating a software image of a reference machine on at least one destination machine is conducted by a processor of the reference machine. The processor receives a mode designator indicative of a configuration of the at least one destination machine to which the software image of the reference machine is to be copied. The processor persists the received mode designator associated with the software image of the reference machine so that it is accessible to the at least one destination machine after the software image is copied to the at least one destination machine.

In accordance with another embodiment hereof, a non-transitory computer readable storage medium has computer-executable instructions which, when executed, carry out a method for configuring, on a destination machine, a software image copied from a reference machine. The method includes retrieving, by the destination machine, a mode designator indicating a configuration of the destination machine, and configuring the destination machine by executing a subset of configuration commands. The subset is selected from a set of configuration commands. The set includes at least one configuration command that does not pertain to the configuration designated by the retrieved mode designator and is not in the subset.

In accordance with still another embodiment hereof, a computer-implemented system is suitable for deploying a software image. The system includes a reference machine, a software image on the reference machine, and a mode designator received by the reference machine. The mode designator is indicative of a configuration of at least one destination machine to which the software image of the reference machine is to be copied. The system further includes a mode storage location within the software image of the reference machine for storing the mode designator within the software image so that the mode designator is copied to the at least one destination machine as part of the software image. A first plurality of software instructions is provided on the reference machine to be run on the reference machine prior to copying the software image to the at least one destination machine. A second plurality of software instructions is also provided on the reference machine to be run on the at least one destination machine to configure the at least one destination machine after the software image is copied thereto. At least one of the second plurality of software instructions on the reference machine has a mode attribute that marks it for exclusion from being run on the at least one destination machine based on a comparison of the mode attribute to the mode designator, thereby saving time in configuring the at least one destination machine.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic drawing of an exemplary network of computing machines with which the present invention may be implemented;

FIG. 2 is a simplified block diagram of an exemplary computing machine including a software image having features to facilitate rapidly configuring the software image on itself or on other computing machines;

FIG. 3 is a flowchart showing an exemplary process for preparing the software image of a reference computing machine for deployment; and

FIG. 4 is a flowchart showing an exemplary process for configuring a newly loaded software image on a destination computing machine.

### DETAILED DESCRIPTION

Techniques, including a preferred embodiment of the invention, are described hereinbelow for configuring software images and deploying them on different computing machines, and for reducing the time needed to configure computing machines that receive deployed software images.

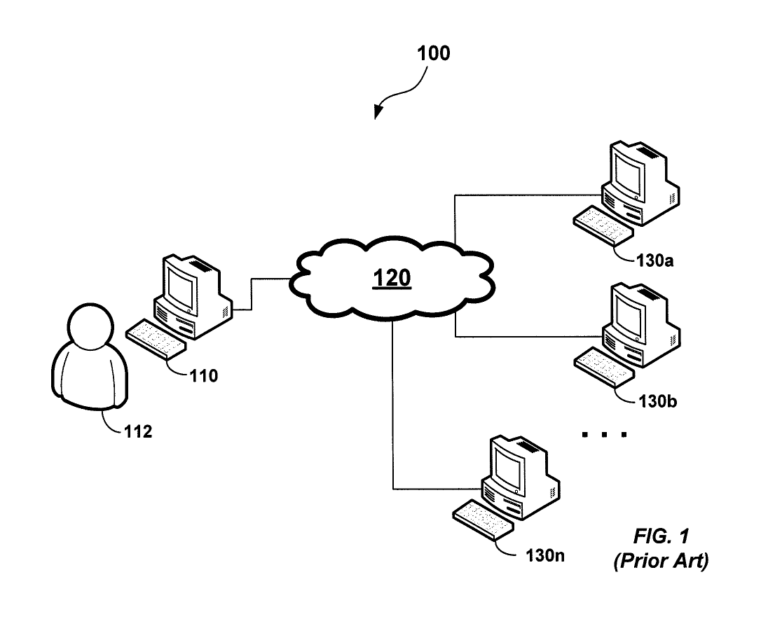

FIG. 1 shows an exemplary array 100 of computing machines. The array 100 includes a reference machine 110 operated by a user 112, a network 120, such as a Local Area Network, Wide Area Network, or the Internet, and a number of destination machines 130a-n.

In the customary arrangement, the user 112 prepares the reference machine 110 for cloning, such as by running SYSPREP's Generalize feature. The user 112 then copies the software image of the reference machine 110 to the destination machines 130a-n over the network 120. The destination machines 130a-n are then each caused to boot. As part of its boot sequence, each destination machine generally runs commands to bind its newly loaded software image to its hardware, such as by running SYSPREP's Specialize feature.

With the arrangement of FIG. 1, a single software image can be prepared and deployed to a large number of computing machines 130a-n. Any changes subsequently made to the software image of the reference machine 110 can be propagated to the destination machines 130a-n by reexecuting the Generalize-Copy-Specialize process. Changes not requiring wholesale reconfigurations of the destination machines may be achieved simply by copying affected files from the reference machine 110 to the destination machines 130a-n and updating pertinent settings.

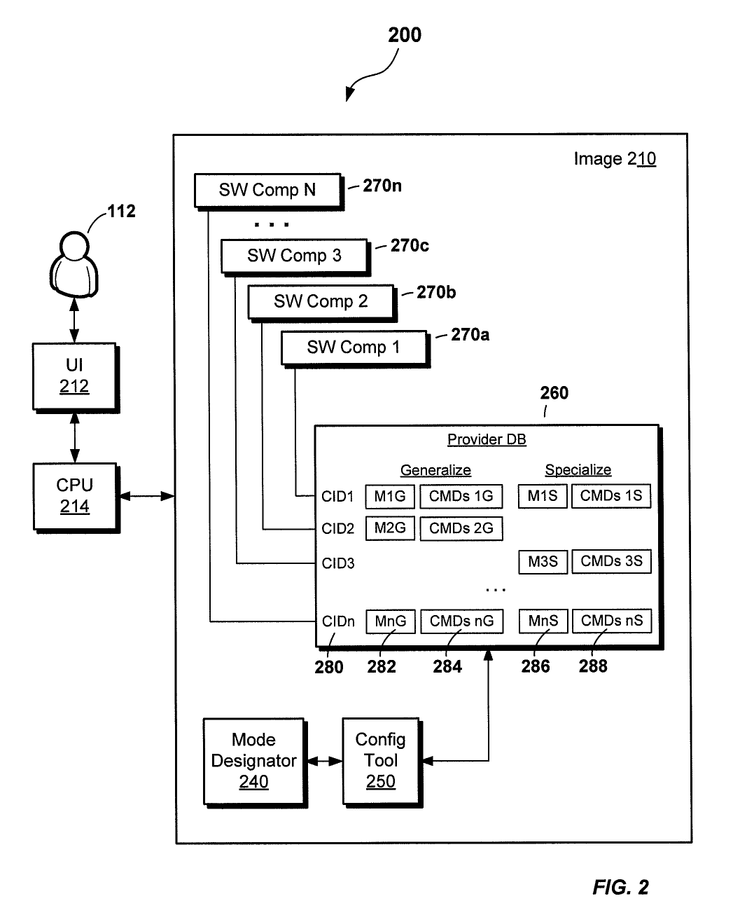

FIG. 2 is a block diagram of a computing machine 200 configured in accordance with an illustrative embodiment of the invention. The computing machine 200 may be operated by a user 112 and includes a software image 210, a user interface 212 (e.g., keyboard, mouse, and monitor), and a processor or CPU 214. The software image 210 preferably includes all of the operating system, user software, and data stored on the disk drive, flash memory drive, or other nonvolatile storage medium used by the machine 200.

Included among the elements of the software image 210 are a mode designator 240, a configuration tool 250, a data collection such as a provider database 260, and a number of software components 270a-n. Although current and previous versions of the Windows operating system included a configuration tool (SYSPREP) and a provider database, these have been modified as shown in FIG. 2 in accordance with the invention to provide faster operation.

The mode designator 240 is a non-volatile part of the software image, which persists and survives copying of the software image from the reference machine to the destination machines. In Windows machines, the mode designator 240 is preferably a key in the registry; however, it may also be any other type of persistent setting, such as data stored in a file. The mode designator 240 is preferably received from the user 112 of the reference machine via the user interface 212 and the CPU 214.

The provider database 260 is also stored within the software image 210. It is preferably a file, such as an XML file; however, it may be implemented in any number of ways, such as with other types of files, or with registry settings.

The software components 270a-n are combinations of executables and registry settings. Software components generally register with the operating system when they are installed. For some components, this registration process includes registering providers with the provider database 260. “Providers” are configuration commands, such as registrations of DLLs, calls to DLLs, calls to component entry points, file manipulations, and/or registry actions, which are specific to the software components that register them.

Providers may be registered for one or more different phases, including: a first phase in which the reference machine is prepared for cloning (e.g., Generalize); and a second phase in which the destination machines are configured after cloning (e.g., Specialize). Some components register providers for the first phase only. Others register providers for the second phase only. Still others register providers for both phases, whereas some do not register providers for either phase. Most components do not register providers, as they do not require any particular actions either before or after cloning. For example, the Windows operating system includes over 14,000 components, whereas fewer than 100 components register providers with the provider database 260.

The provider database 260 includes a number of records. Each record is associated with a component identifier 280 (e.g., CID1-n), which identifies the component that registered the provider. Each record may include a provider 284 registered for the first phase (e.g., CMDs 1G-nG) and/or a provider 288 registered for the second phase (e.g., CMDs 1S-nS).

The provider database 260 also includes mode attributes 282 (e.g., M1G-nG) and 286 (e.g., M1S-nS). In some embodiments, a mode attribute may be associated with each component 270a-n. Such a mode attribute may apply to each of the providers registered for that component. Though, this information may be stored in any suitable way. For example, in other embodiments, a mode attribute may be associated with each of the providers registered in the provider database 260, and each mode attribute 282/286 designates one or more modes to which the corresponding provider applies. Some providers apply to a single mode, whereas others apply to more than one.

The term “mode,” as used in the terms “mode designator” and “mode attribute,” refers to configurations of destination machines. There are many possible modes, including, for example, virtual machine mode, OEM machine mode (i.e., suitable for a particular manufacturer configuration), laptop mode, desktop mode, smart phone mode, PDA mode, and simply default mode, i.e., a mode for machines of unknown or standard configuration. The mode designator 240 is preferably set to a single value to indicate a single mode, i.e., the configuration of the destination machines, whereas the mode attribute 282/286 for a provider is generally set to up to many values for designating all of the modes to which the provider applies.

The configuration tool 250 is preferably run for a particular phase by executing the providers for that phase which have mode attributes that match the mode designator. For example, during execution of the first phase, the configuration tool 250 examines the mode attribute 280 of each record registered for the first phase. For each such record, the provider is executed (e.g., a DLL is called and/or registry settings are changed) if the value of the mode attribute 280, or one of the values of the mode attribute (if multiple values are provided) matches the mode designator 240. Otherwise, the provider is not executed. A similar process is conducted during the second phase.

Of course, there are other ways of selectively running providers. For example, mode attributes 282/286 can be defined not according to the modes to which they apply, but according to the modes to which they do not apply. For example, rather than setting a mode attribute to “PDA mode” to indicate that an associated provider should be run when the mode designator 240 is set to “PDA mode,” the mode attribute may instead be set to “Not PDA Mode.” In this scenario, the associated provider would be skipped if the mode designator 240 was set to “PDA mode.” In both cases for selectively running providers, some providers are run whereas others are excluded, so the effect is the same. The providers for any given phase and mode are thus generally a subset of all providers for that phase. Only the subset of providers are run. All others are excluded.

Preferably, all providers are run when the mode designator 240 is set to “default,” i.e., indicating destination machines of unknown or standard configuration. However, this is not necessarily the case. For example, components may install providers in the provider database 260 that are applicable only to specific, nonstandard configurations, such as smart phones. As these providers would not be applicable to default machines, they would normally be excluded from execution on default machines.

It is understood that the software image 210 depicts that of both the reference machine and the destination machines. During the normal process of cloning software images, the image is prepared and saved on a reference machine, and then copied to destination machines, where it is reconfigured. Therefore, the software image 210 ultimately resides on both the reference machine and the destination machines.

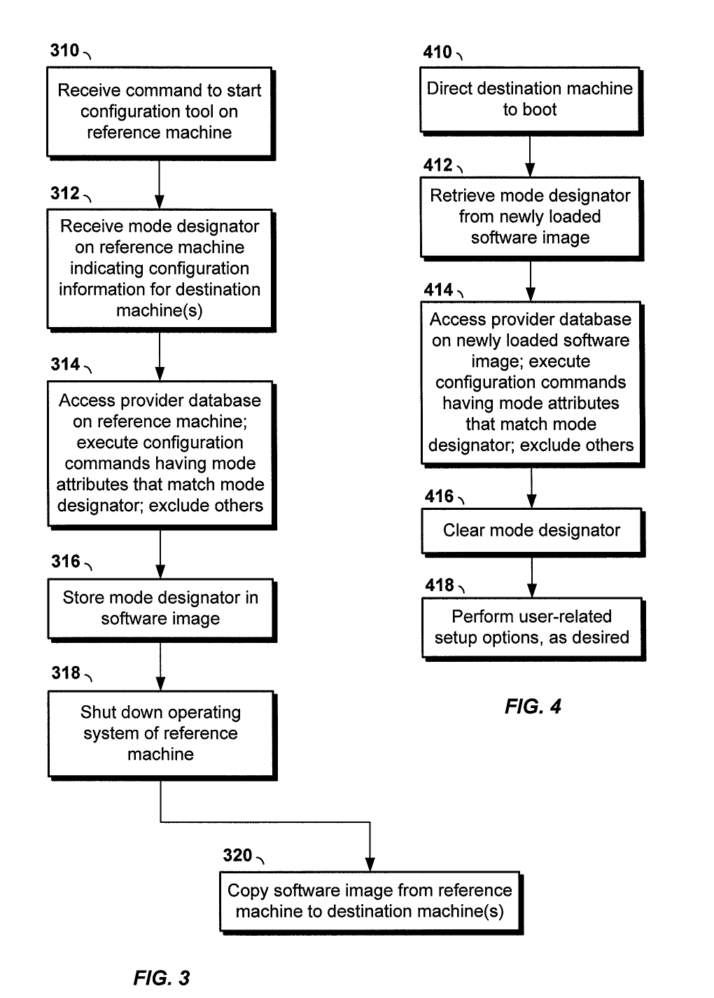

FIG. 3 shows a process for conducting the first phase described above, i.e., preparing the software image of a reference machine for cloning (e.g., Generalize). At step 310, a reference machine (e.g., machine 110) receives a command to start a configuration tool for preparing the image of the reference machine for cloning. On a Windows machine, this act is preferably conducted by invoking the SYSPREP tool from the command line. The command is preferably input by a user (e.g., 112) via the user interface (e.g., 212) of the reference machine. However, it may alternatively be supplied by a computer program conducting this phase automatically or semi-automatically.

At step 312, the reference machine receives a mode designator value. The mode designator value identifies a known or expected configuration of the destination machine or machines. On a Windows machine, the mode designator is preferably an argument passed to the SYSPREP tool. For example, the user 112 could click START→Run→Sysprep/mode:Mode, wherein “Mode” is the value of the mode designator. Non-limiting examples of mode designator values include Virtual Machine, OEM, Laptop, Desktop, Smart Phone, PDA, and Default.

At step 314, the reference machine running the configuration tool accesses a data collection (e.g., the provider database 260) and thereby gains access to the specific list of providers for the first phase. The reference machine inspects the mode attributes (e.g., 282) associated with these providers and executes those having mode attributes that match the received mode designator value, or excludes those having mode designators that indicate exclusion. Regardless of how the matching is done, some providers are executed whereas others may be excluded.

At step 316, the reference machine stores the mode designator in the software image. On a Windows machine, the mode designator is preferably stored in a registry key; however, it may alternatively be stored in another non-volatile location, such as a file. Preferably, the configuration tool running on the reference machine also sets a key in the registry to indicate that the configuration tool has been run.

At step 318, the first phase is complete and the operating system of the reference machine is shut down. The software image is then available for copying to destination machines (step 320). A number of disk imaging programs are available for this purpose.

It is understood that the mode designator may be stored at any time after it is received. Therefore, it is not necessary that step 316 be performed at the point in the sequence shown. Similarly, it is not necessary that the mode designator be received after the command is issued to start the configuration tool. It could be received before the tool is started or simultaneously with the tool being started. Indeed, although steps 310 and 312 are shown as logically separate steps appearing in a particular sequence, they are preferably conducted simultaneously on a Windows machine, wherein the mode designator is supplied as an argument to the SYSPREP command.

FIG. 4 shows a process for conducting the second phase described above, i.e., configuring the software image on a destination machine after cloning (e.g., Specialize). This process begins after the software image from the reference machine has been loaded, and may be conducted on each destination machine that receives the software image.

At step 410, the destination machine is made to boot. On a physical machine, this step is generally initiated by powering on the machine or pressing a button to reset the machine. On a virtual machine, this step is generally initiated by starting a new instance of the operating system, such as by issuing a command from a host operating system resident on the same physical machine or by directing a hypervisor to boot the newly cloned operating system in a virtualized environment, such as Virtualized Hard Drive (VHD).

While booting, the destination machine automatically starts the configuration tool (e.g., the tool 250). In a Windows machine, the normal boot sequence checks a registry key to determine whether the configuration tool has been run. If the key has been set, the machine automatically starts the configuration tool (e.g., SYSPREP) during the boot sequence.

At step 412, the configuration tool running on the destination machine retrieves the mode designator (e.g., mode designator 240) from the newly loaded software image. If the mode designator has been stored in a registry key, this act involves reading the registry key. Otherwise, it involves reading the file or other non-volatile part of the software image in which the mode designator has been stored. It is understood that the mode designator retrieved is a copy of the mode designator originally stored by the reference machine (at step 316, FIG. 3), which has been persisted in the software image.

At step 414, the configuration tool running on the destination machine accesses the data collection, e.g., the provider database 260, which has come to the destination machine in the software image from the reference machine. The configuration tool executes all providers having mode attributes that match the value of the retrieved mode designator, or excludes those having mode designators that indicate exclusion. Regardless of how the matching is done, some providers are executed whereas others may be excluded.

At step 416, the mode designator is preferably cleared from the software image, such as by clearing the registry key or file entry where the mode designator has been stored. If the machine is a Windows machine, the registry key indicating that SYSPREP has been run is also cleared.

At this point in the process, the software image of the destination machine is preferably bound to its hardware and environment. Users may then log on to the destination machine, and other configuration tasks may be conducted (step 418) to establish user-specific settings and options, as desired.

It is not necessary that step 416 be performed at the location in the sequence shown. The mode designator may be cleared at any time after it is retrieved. For example, it can be read into memory and immediately cleared from the registry or other location, with the configuration tool using the version from memory for completing configuration tasks.

The processes of configuring reference machines and destination machines, as shown in FIGS. 3 and 4, can save significant time as compared with prior techniques, especially when the destination machines are virtual machines. For example, since virtual machines are defined by their software and state information, they are effectively hardware-independent. By running the configuration tool on a reference machine with the mode designator set for virtual machines, the providers for configuring hardware drivers on the destination machines can be omitted. It has been observed that the hardware driver for configuring the Plug-and-Play adapter itself accounts for approximately 90% of all configuration time on destination machines. Therefore, by allowing the configuration tool to skip this single step, the time needed to configure a virtual machine can be reduced by 90% as compared with default machines. A process that previously took minutes can thus be performed in seconds. More time can be saved by omitting other hardware drivers and non-essential components. It is expected that users of virtual machines, who may need to wait patiently for their machines to be dynamically deployed and configured, will appreciate the reduced delays and therefore will enjoy a better overall user experience.

Having thus described several aspects of at least one embodiment of this invention, it is to be appreciated that various alterations, modifications, and improvements will readily occur to those skilled in the art.

For example, although certain techniques are shown and described in connection with Windows machines running the SYSPREP tool, these techniques may be used in connection with other operating systems and/or other tools. The invention is not limited to Windows systems.

Although the reference computer 110 is shown as being operated by a user 112, this is merely an example. Alternatively, the reference machine may perform tasks automatically, under control of a program installed on the reference machine or under control from another computer. In addition, while one might surmise that the reference machine 110 is a physical computer, this is not required. It may alternatively be a virtual machine.

As shown and described, the reference machine 110 and the destination machines 130a-n are different machines connected together by a network 120. Alternatively, some or all of the machines 110 and 130a-n may be virtual machines running on the same physical hardware, with no network 120 interconnecting them. In one example, all of the machines are virtual machines running on the same server. Though, any suitable mechanism may be used to transfer information from a reference machine 110 to destination machines 130a-n, including, for example, transferring that information onto a media, such as a thumb drive or a DVD, that is moved between machines.

As shown and described, the software image 210 includes a number of software components 270a-n. However, this is merely an example. Not all operating systems require software components, per se. For these operating systems, the provider database 460 would not specifically associate providers with components, but rather with programs or processes. The effects would be the same, however, with some programs or processes involving configuration commands prior to cloning and/or after cloning.

As shown and described, the mode designator 240 is part of the software image. The mode designator is effectively planted in the image by the reference machine and persisted to the destination machines. However, this is not required. According to one alternative, the mode designator is input to the destination machines after cloning, rather than being brought over within the image. Configuration commands on each destination machine are then specifically tailored based on matching the mode attributes in the provider database of the destination machine with the mode designator newly entered on the destination machine.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device. In addition, the term “machine” as used herein is synonymous with the term “computer,” and machines include both physical machines and virtual machines.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable storage medium or media can be transportable, such that the program or programs stored thereon can be loaded onto one or more different computers or other processors to implement various aspects of the present invention as discussed above. As used herein, the term “non-transitory computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Similarly, the term “machine” is used herein in a generic sense to refer both to physical machines and virtual machines.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of replicating a software image of a reference machine on at least one destination machine, comprising:
operating at least one processor to perform a method comprising:
receiving, by the reference machine, a mode designator indicative of a configuration of the at least one destination machine to which the to software image of the reference machine is to be copied; and
persisting the received mode designator associated with the software image of the reference machine so that it is accessible to the at least one destination machine after the software image is copied to the at least one destination machine.

2. The method as recited in claim 1, wherein:
the software image comprises a plurality of configuration commands, each being associated with at least one mode attribute, each mode attribute indicating a configuration of a destination machine to which the configuration command is applicable; and
the method further comprises selectively executing a subset of the configuration commands of the plurality of configuration commands, the subset selected based on matching mode attributes of the plurality of configuration commands and the mode designator.

3. The method of claim 2, wherein the mode attributes of the configuration commands have values selected from a set comprising different mode designator values for default machines and for virtual machines.

4. The method as recited in claim 2, wherein selectively executing the subset of the configuration commands generalizes the software image of the reference machine by removing machine dependent settings.

5. The method as recited in claim 1, further comprising:
accessing a plurality of configuration commands on the reference machine for preparing the software image for deployment to the at least one destination machine;
forming a subset of the plurality of configuration commands, the subset omitting at least one of the plurality of configuration commands based on the received mode designator, and
running the subset of the plurality of configuration commands on the reference machine.

6. The method as recited in claim 5,
wherein the software image of the reference machine comprises a plurality of software components,
wherein the act of accessing comprises accessing a data collection of configuration commands organized by software component wherein at least one software component represented in the data collection is associated with a mode attribute, and
wherein the act of running comprises running or excluding from running configuration commands in the data collection for software components based on comparisons of the respective mode attributes for the software components and the received mode designator.

7. The method of claim 2, wherein the mode attributes of the configuration commands have values selected from a set comprising different mode attribute values for at least two of default computers, virtual machines, OEM computers, tablet computers, smart phones, and PDAs.

8. The method as recited in claim 5, wherein:
the destination machine is a virtual machine; and
the at least one omitted configuration command is for configuring hardware drivers.

9. The method as recited in claim 8, wherein the at least one configuration command for configuring hardware drivers comprises a command for configuring a plug-and-play adaptor.

10. The method as recited in claim 1, further comprising:
applying a software upgrade or patch to the reference machine; and
copying the updated or patched software image of the reference machine to the at least one destination machine.

11. A non-transitory computer readable storage medium having computer-executable instructions which, when executed, carry out a method for configuring, on a destination machine, a software image copied from a reference machine, the method comprising:
retrieving, by the destination machine, a mode designator indicating a configuration of the destination machine; and
configuring the destination machine by executing a subset of configuration commands, the subset being selected from a set of configuration commands, the set comprising at least one configuration command that does not pertain to the configuration designated by the retrieved mode designator and is not in the subset.

12. The non-transitory computer readable storage medium as recited in claim 11, wherein the destination machine is a virtual machine, and wherein the at least one configuration command that does not pertain to the configuration comprises a command for configuring hardware drivers.

13. The non-transitory computer readable storage medium as recited in claim 12, wherein the command for configuring hardware drivers comprise a command for configuring a plug-and-play adaptor.

14. The non-transitory computer readable storage medium as recited in claim 11,
wherein the software image on the destination machine comprises a plurality of software components,
wherein the step of accessing comprises accessing a data collection of configuration commands organized by software component wherein at least one software component represented in the data collection is associated with a mode attribute, and
wherein the step of executing comprises executing or omitting from executing configuration commands for software components based on comparisons of the respective mode attributes of the software components and the retrieved mode designator.

15. The non-transitory computer readable storage medium as recited in claim 11, wherein the mode attributes of the configuration commands have values selected from a set comprising different mode attributes for at least two of default computers, virtual machines, OEM computers, tablet computers, smart phones, and PDAs.

16. The non-transitory computer readable storage medium as recited in claim 11, further comprising:
clearing the retrieved mode designator from the software image of the destination machine.

17. The non-transitory computer readable storage medium as recited in claim 11, wherein the act of configuring specializes the software image of the destination machine by adding machine dependent settings.

18. A computer-implemented system for deploying a software image, comprising:
a reference machine;
a software image on the reference machine;
a mode designator received by the reference machine, wherein the mode designator is indicative of a configuration of at least one destination machine to which the software image of the reference machine is to be copied;
a mode storage location within the software image of the reference machine for storing the mode designator within the software image so that the mode designator is copied to the at least one destination machine as part of the software image;
a first plurality of software instructions on the reference machine to be run on the reference machine prior to copying the software image to the at least one destination machine; and
a second plurality of software instructions on the reference machine to be run on the at least one destination machine to configure the at least one destination machine after the software image is copied thereto, wherein at least one of the second plurality of software instructions on the reference machine has a mode attribute that marks it for exclusion from being run on the at least one destination machine based on a comparison of the mode attribute to the mode designator, thereby saving time in configuring the at least one destination machine.

19. The computer-implemented system as recited in claim 18, wherein at least one of the first plurality of software instructions on the reference machine has a mode attribute that marks it for exclusion from being run on the reference machine based on a comparison of the mode attribute to the mode designator.

20. The computer-implemented system as recited in claim 18, wherein the mode designator designates whether the at least one destination machine is of unknown configuration or a virtual machine.
